(19) United States
(12) Patent Application Publication
(10) Pub. No.: US 2026/0320535 A1
(43) Pub. Date: Oct. 15, 2026

(54) SYSTEM AND METHOD FOR GENERATING PERFORMANCE INDICATORS

(71) Applicant: Ask2.ai, Inc., Delray Beach, FL (US)

(72) Inventors: Ali HIRSA, New York, NY (US); Satyan MALHOTRA, Delray Beach, FL (US); Federico KLINKERT, Delray Beach, FL (US)

(21) Appl. No.: 19/481,069

(22) PCT Filed: May 1, 2024
(86) PCT No.: PCT/US2024/027207

§ 371 Date: Nov. 3, 2025

Related U.S. Application Data
(60) Provisional application No. 63/463,207, filed on May 1, 2023.

(51) Int. Cl. G06Q 10/0639; G06Q 40/06

(52) U.S. Cl. CPC G06Q 10/06398; G06Q 40/06

(57) ABSTRACT

An approach for converting performance information for assessment of financial managers to a sports-based performance evaluation metric is disclosed. The approach comprises receiving a data set relating to performance information associated with a plurality of users in managing financial instruments, wherein the performance information includes returns for the financial instruments. The approach also comprises normalizing the data set. The approach also comprises generating a plurality of scores for each of the plurality of users based on the normalized data set according to a scoring rule of a sport. The approach also comprises mapping the data set to activities associated with the sport to determine statistical information for each of the plurality of users. The approach further comprises initiating presentation of the plurality of scores and the statistical information for evaluation of the plurality of users.

### RELATED APPLICATIONS

This application claims the benefit of U.S. Provisional Patent Application No. 63/463,207, titled “System and Method for Generating Performance Indicators,” filed May 1, 2023, the entire disclosure of which is hereby incorporated by reference herein.

### BACKGROUND

Despite the current set of tools, data analysts in all industries face the daunting task of analyzing an overwhelming barrage of information to determine meaningful, impactful data. One particular sector involves the financial industry, such as wealth management. Both wealth managers and associated consumers share the responsibility for achieving monetary targets. The selection of vast number of profitable assets and investment portfolios require allocation of enormous resources in personnel and technology. Existing systems that wealth managers rely on for financial analysis have not kept based with development in data processing technology. The challenge is magnified when the data (e.g., news, social media, etc.) significantly affects market conditions in real-time. On the consumer side, choosing of one or more successful money managers is difficult because evaluating performance of these managers can be as extensive an undertaking as evaluating the financial market itself, particularly given the variety of esoteric principles and jargon to assess performance.

### SOME EXAMPLE EMBODIMENTS

Therefore, there is a need for an approach that enables readily assessing performance of financial managers.

According to one embodiment, a method comprises receiving a data set relating to performance information associated with a plurality of users in managing financial instruments, wherein the performance information includes returns for the financial instruments. The method also comprises normalizing the data set. The method also comprises generating a plurality of scores for each of the plurality of users based on the normalized data set according to a scoring rule of a sport. The method also comprises mapping the data set to activities associated with the sport to determine statistical information for each of the plurality of users. The method further comprises initiating presentation of the plurality of scores and the statistical information for evaluation of the plurality of users.

According to another embodiment, an apparatus comprises at least one processor, and at least one memory including computer program code for one or more computer programs, the at least one memory and the computer program code configured to, with the at least one processor, cause, at least in part, the apparatus to receiving a data set relating to performance information associated with a plurality of users in managing financial instruments. The performance information includes returns for the financial instruments. The apparatus is also caused to normalize the data set. The apparatus is also caused to generate a plurality of scores for each of the plurality of users based on the normalized data set according to a scoring rule of a sport. The apparatus is also caused to map the data set to activities associated with the sport to determine statistical information for each of the plurality of users. The apparatus is further caused to initiate presentation of the plurality of scores and the statistical information for evaluation of the plurality of users.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between the service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of an AI-based decision support platform, according to one embodiment;

FIG. 2 is a diagram of the components of the AI-based decision support platform of FIG. 1, according to one embodiment;

FIG. 3 is a diagram of the AI-based decision support platform of FIG. 1 interacting with various data sources, according to one embodiment;

FIG. 4A is a flowchart of a process for assessing performance data by the AI-based decision support platform of FIG. 1, according to one embodiment;

FIG. 4B is a flowchart of a process for evaluating wealth managers by the AI-based decision support platform of FIG. 1, according to one embodiment;

FIG. 4C is a diagram of a graphical user interface (GUI) relating to presentation of performance indicators produced by the AI-based decision support platform of FIG. 1, according to one embodiment;

FIGS. 5A-5H are diagrams of a graphical user interface (GUI) relating to data management processes performed by the AI-based decision support platform of FIG. 1, according to one embodiment;

FIGS. 6A and 6B are diagrams of a GUI relating to asset allocation processes performed by the AI-based decision support platform of FIG. 1, according to one embodiment.

FIGS. 7A-7D are diagrams of a GUI relating to security selection processes and index generation processes performed by the AI-based decision support platform of FIG. 1, according to one embodiment;

FIG. 8 is a diagram of a neural network that can be implemented by the AI-based decision support platform of FIG. 1, according to one embodiment;

FIG. 9 is a diagram of hardware that can be used to implement various example embodiments;

FIG. 10 is a diagram of a chip set that can be used to implement various example embodiments; and

FIG. 11 is a diagram of a mobile terminal (e.g., handset) that can be used to implement various example embodiments.

### DESCRIPTION OF SOME EMBODIMENTS

Examples of a method, apparatus, and computer program for generating indices relating to performance of assets or portfolios are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

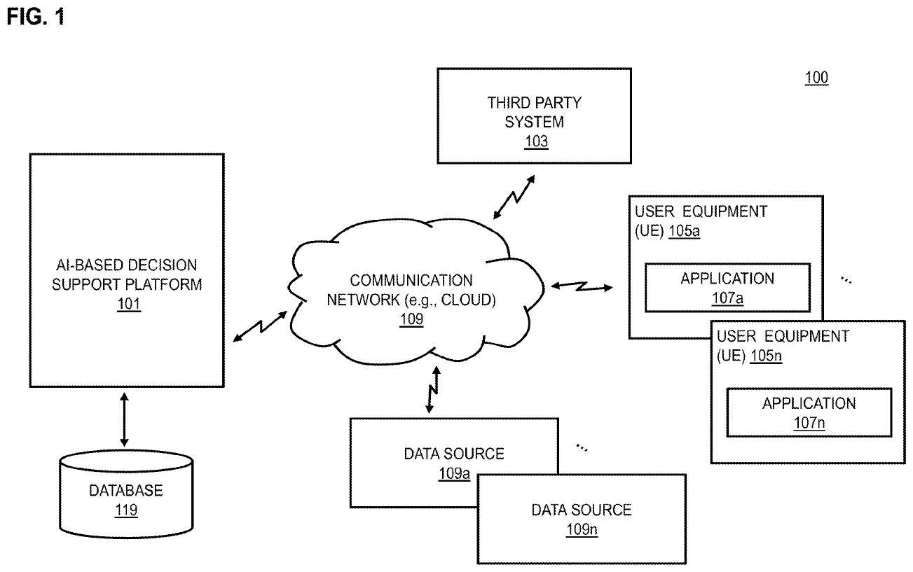

FIG. 1 is a diagram of AI-based decision support platform, according to one embodiment. To address the noted drawbacks of conventional systems and approaches to processing the vast amount of data for proper selection of investments, a system 100 of FIG. 1 includes an AI-based decision support platform 101 that introduces the capability to assess and to measure real-time impact of an asset/security or portfolio. Additionally, the platform 101 can supplement and/or integrate with a third party system 103, which may be a conventional financial analysis system that is utilized by financial advisors. The platform 101 can parse through numerous datasets, models, viewpoints, visuals, etc. concurrently to continually assess historic and predicted performance within each aspect of the asset life cycle, subject to defined or suggested objective functions. By way of example, the platform 101 can supplement the financial advisor's experience-based, traditional portfolio decisions with Artificial Intelligence-powered visualizations for assessing a Security or Portfolio (A), evaluating the predicted path profile of A, comparing A with B (and transition of A to B), and measuring real-time impact on A. With respect to the third party system 103, the platform 101 integrates within the technology infrastructure of the system 103 to execute user-defined or optimized objective functions and can also run the processes on existing portfolios.

Although the platform 101 is explained utilizing use cases involving applications to the financial sector, it is contemplated that the platform 101 can unify other forms of measures/metrics (e.g., operational performance, etc.).

Among other functions and features, the platform 101 can harness research, data, programming and advanced AI methodologies to address daunting development possibilities centered around the following: removing the drudgery of complex tasks to drive efficiency; providing visuals that are interpretable to facilitate more creative work; and determining meaning research data. Advantageously, the transformation or conversion of standard metrics into a sports-based performance indicator, users can immediately understand and appreciate the performance of financial advisors, and portfolio managers.

There is an abundance of relevant measures (exceeding 100) for assessing a manager's performance drawing on volatility, drawdowns, returns, and other aspects. Thus, the average consumer can easily be overwhelmed by having to consider these factors. In recognition of this, the platform 101 has the capability to generate a sports-based performance metric so that consumers can immediately understand how well wealth managers are doing, both currently and historically. It is contemplated that any popular sports (e.g., golf, baseball, etc.) can be employed, such that traditional performance indicators can be converted according to the scoring rule and relevant statistics of the particular sport. Such transformation of financial metrics into a more immediately relatable metric is tremendously useful for consumers. According to one embodiment, a golf scorecard and handicap-based metric can be more edifying than raw performance data. Table 1 below provides a description of golf scoring and references that can be employed to generate performance indicators:

TABLE 1

| Parameter | Description |
|---|---|
| Score | For each hole, getting the baseline score is called a Par or in scoring |
| | terms it implies 0 deviation from the expected strokes it should take |
| | to complete the hole. On the positive side, a Birdie is completing |
| | the hole with one less stroke (so −1 deviation), Eagle is taking two |
| | less strokes (so −2 deviation), and so on. On the negative side, a |
| | bogey is completing the hole with one more stroke (so a +1 |
| | deviation), double bogie is two more strokes (so a +2 deviation) |
| | and so on. The overall objective is to have the total number of |
| | strokes taken to complete the course be as less as possible (and for |
| | better players less that than the baseline set for the course). The |
| | player that had the least number of strokes wins (given the number |
| | of rounds in the competition/play). |
| Handicap | Is a measure of the golfer's expected performance that is measured as |
| | a function of the course difficulty, their historic performance and other |
| | such factors. These can be applied as a relative measure to the course, |
| | to a particular hole, to assess player consistency, to compare players, |
| | and so on. |
| Fairway | Is the area between the tee (starting point) and the pin (ending point on |
| | the green), where the playing or approach area to the target is generally |
| | the best as the grass is cut the finest. |

It is noted that a golf scorecard measures the players performance versus those set as a baseline for the course, given the guidelines set by the pertinent governing bodies.

Much like the financial markets, every play on the golf course presents its unique set of challenges. And, as in assessing a golfer, the platform 101 constructs performance evaluation metrics that allow consumers to handicap the manager and assess their running scorecards. This provides insights into their approach or desired play profile with views on those that favor the fairway, those that may be more aggressive so risk bogies, double bogies, one-offs, etc.

According to another embodiment, a baseball statistical measure may be utilized: Batting Average. The Batting Average may be utilized along with an Information Ratio to give a simple assessment of performance versus a target as in a benchmark, index, portfolio, etc.

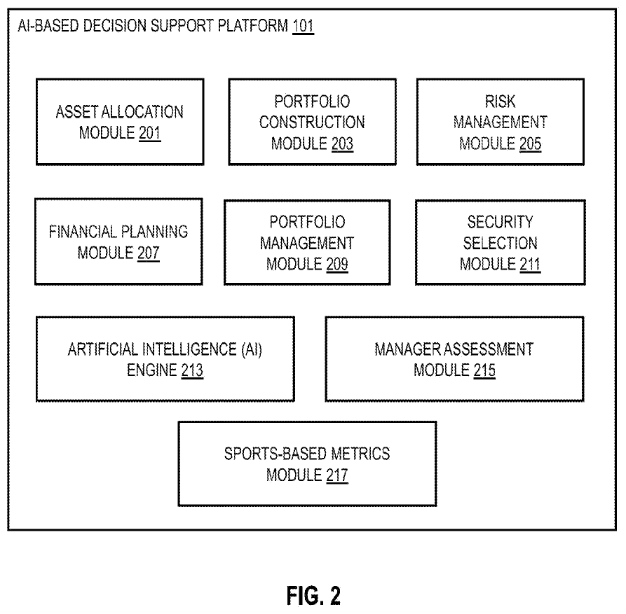

Further details of this sports-based performance evaluation metric are provided with respect to FIG. 2, 4A-4C.

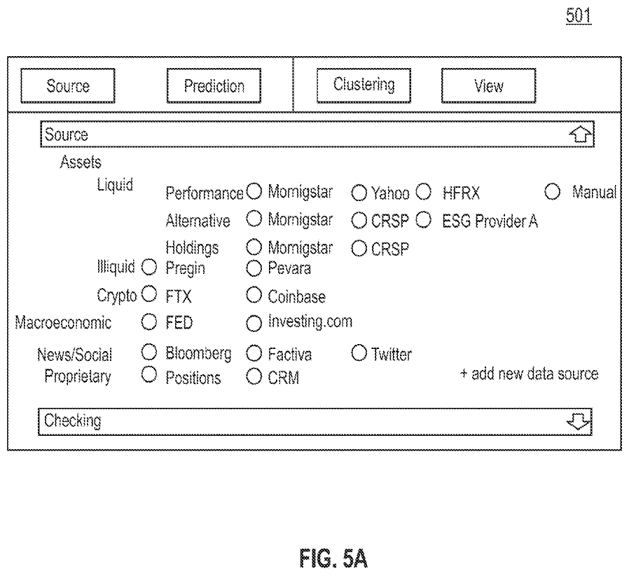

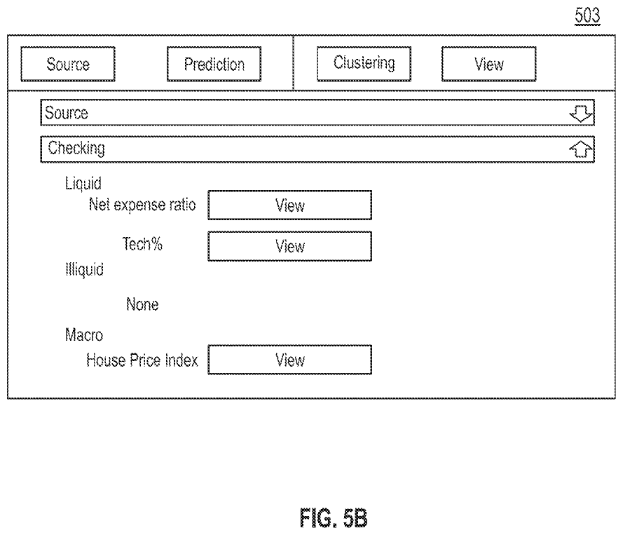

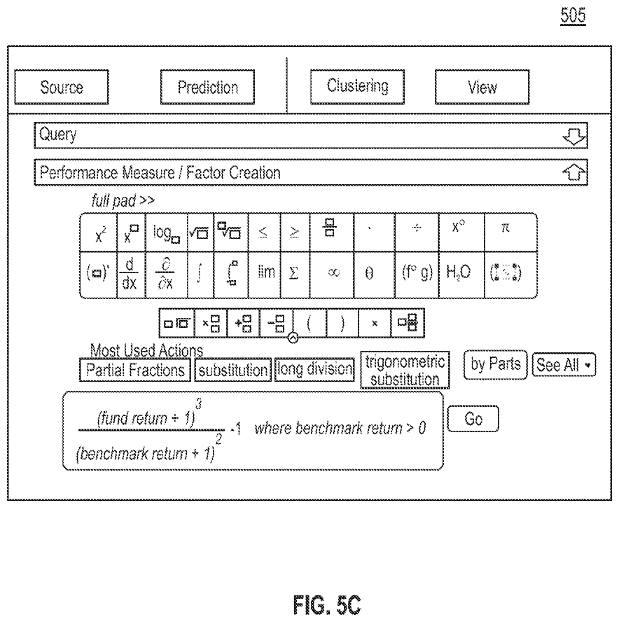

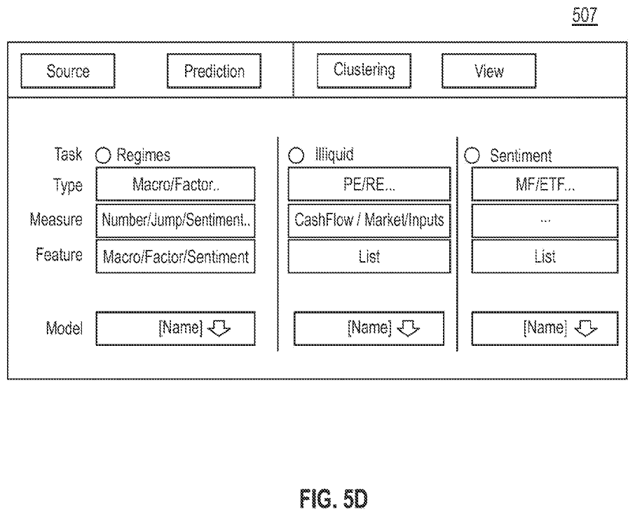

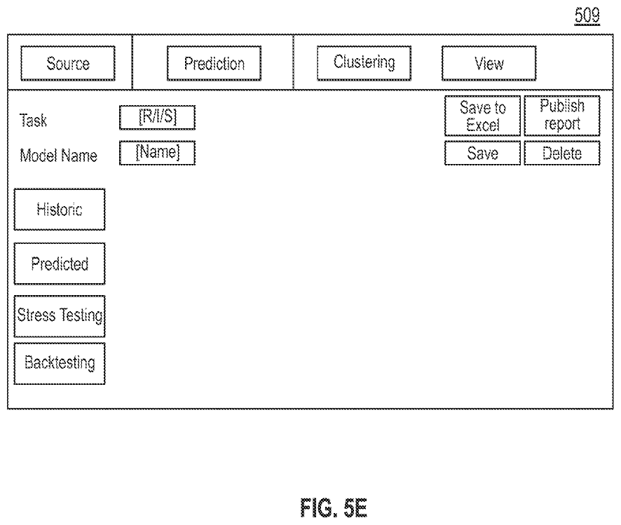

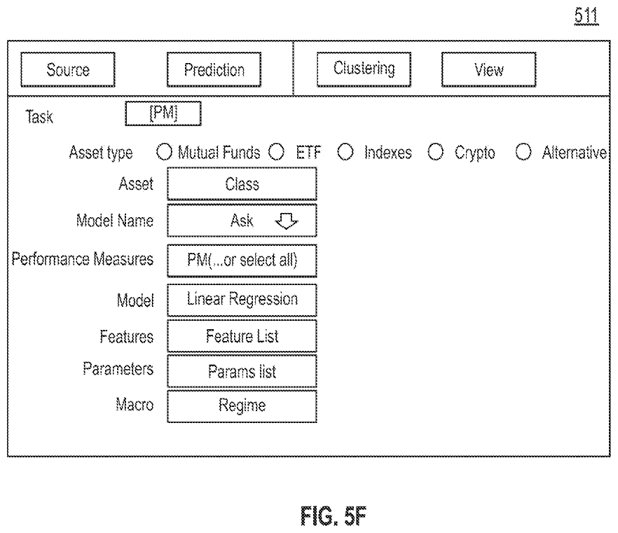

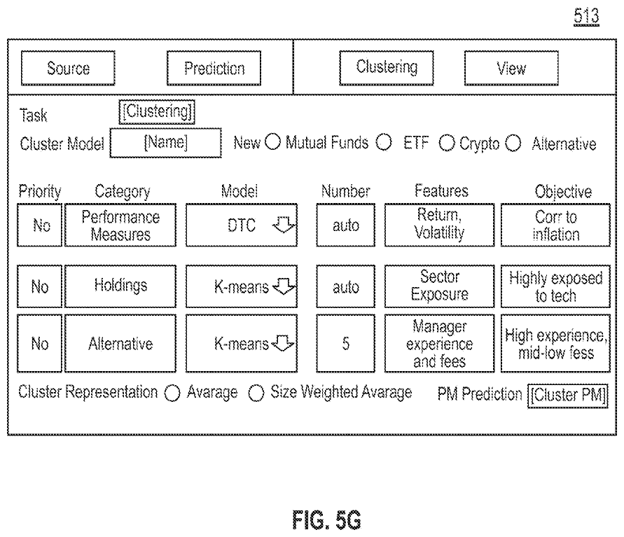

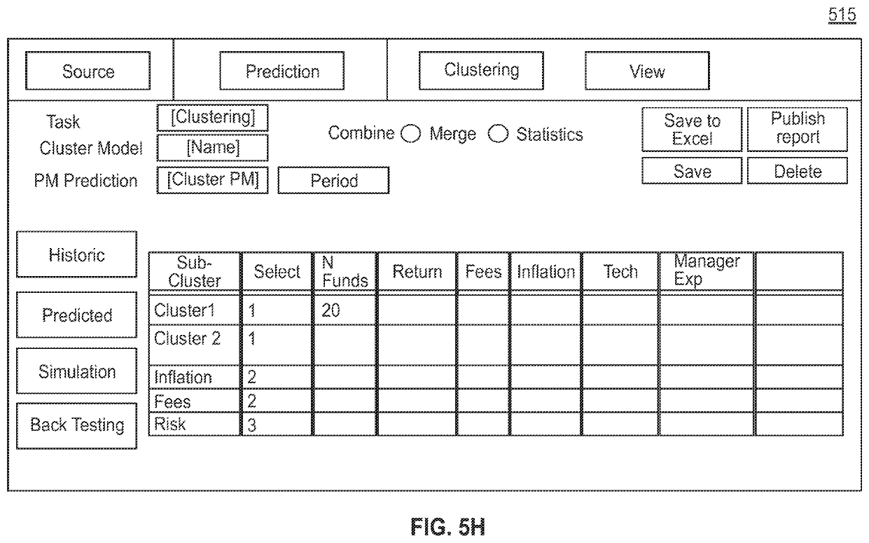

As shown in FIG. 1, the system 100 also comprises user equipment (UE) 105a-105n (collectively referred to as UE 105) that may include or be associated with applications 107a-107n (collectively referred to as applications 107). In one embodiment, the UE 105 has connectivity to the AI-based decision support platform 101 via the communication network 109. Under certain scenarios, the AI-based decision support platform 101 performs one or more functions associated with data analysis in conjunction with the UEs 105a-105n. By way of example, the UE 105 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, a smartphone, a smartwatch, smart eyewear, or any combination thereof, including the accessories and peripherals of these devices, or any combination thereof. It is also contemplated that the UE 105 can support any type of interface to the user (such as “wearable” circuitry, etc.). In one embodiment, the UE 105 may include Global Positioning System (GPS) receivers to obtain geographic coordinates from satellites (not shown) for determining current location and time associated with the UE 105; such GPS information can be utilized to geo-tag images captured by UE sensors (not shown). The UE 105 is capable of supporting a graphical user interface (GUI) that provides the GUI of FIGS. 5-7.

The AI-based decision support platform 101 operates in conjunction with one or more applications resident on an UE 105. By way of example, the applications 107 may be any type of application that is executable at UE 105, such as content provisioning services, camera/imaging application, media player applications, social networking applications, calendar applications, and the like. In one embodiment, the applications 107 may assist in conveying sensor information via the communication network 109. In another embodiment, one of the applications 107 at the UE 105 may act as a client for the AI-based decision support platform 101 and perform one or more functions associated with the functions of the platform 113 by interacting with the platform 113 over the communication network 109.

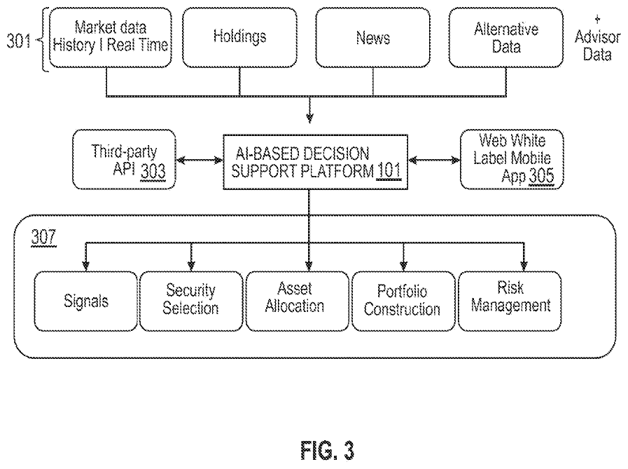

One or more data sources 109a-109n are accessible via the network 109 by the platform 101. The data sources 109a-109n can include any content relevant to making financial decisions relating to securities, such as market data (e.g., historical or real-time market information), news, financial holdings, alternative data (as shown in FIG. 3). The retrieved data can reside within database 111 of the AI-based decision support platform 101. It is contemplated that database 111 can be implemented as a cloud storage system.

The communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5^{th} Generation), 4G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the AI-based decision support platform 101 may be a platform with multiple interconnected components. The AI-based decision support platform 101 may include multiple servers, intelligent networking devices, computing devices, components and corresponding software for providing real-time data analysis. In addition, it is noted that the AI-based decision support platform 101 may be integrated or separated from services platform. Also, certain functionalities of the system 101 may reside within the UE 105 (e.g., as part of the applications 107).

Moreover, the platform 101 can interface with various services systems (not shown), such as notification services, content (e.g., audio, video, images, etc.) provisioning services, application services, storage services, contextual information determination services, social networking services, location-based services, information-based services, etc.

By way of example, UE 105, the AI-based decision support platform 101, the third party system 103 with each other and other components of the communication network 109 using well known, new or still developing protocols (e.g., IoT standards and protocols). In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 2 is a diagram of the components of the AI-based decision support platform of FIG. 1, according to one embodiment. By way of example, the platform 101 includes one or more components for analyzing data to determine selection and/or performance of a security/asset or portfolio. It is contemplated that the functions of these components may be combined in one or more components or performed by other components of equivalent functionality. In this embodiment, the AI-based decision support platform 101 includes the following modules: an asset allocation module 201, a portfolio construction module 203, a risk management module 205, a financial planning module 207, a portfolio management module 209, a security selection module 211, an artificial intelligence engine 213, a manager assessment module 215, and a sports-based metrics modules 217.

The asset allocation module 201 generates a multitude of dynamic allocation/weights based on historic or predicted objective functions (e.g., minimal return of x, max MDD of y, etc.) based on market indices and/or other market data. Additionally, the module 201 can incorporate macro-economic and social data, thereby providing explainability of how allocations are made (e.g., weighting of measures, macro condition, alternative, etc.). The module 201 has the capability to change weights or the complete selection criteria, and perform “what if” analyses; this is conducted for selection, tracking or comparative purposes. Further, the module 201 provides assessment of historic and ongoing tracking error of allocations. Optionally, the module 201 can employ clusters (as opposed to traditional asset class definitions). For example, security clusters can have behavioral, holding or alternative data similarity (for the duration of the assessed period). In effect, the module 201 can satisfy the objective function(s) given evolving market conditions over a particular time horizon.

Among other functions, the portfolio construction module 203 generates dynamic portfolio compositions based on historic or predicted objective function (e.g., min return of x, max MDD of y, etc). The module 203 utilizes the outputs of the asset allocation module 201 and the security selection module 211. As with the asset allocation module 201, the module 203 provides the capability to demonstrate how the composition was made (e.g., relationships, macro condition, alternative, etc.), as well as configure the selection criteria and modify weighting parameters. The module 203 also supports assessment of historic and ongoing tracking error of portfolios; error correction and penalizing functions are employed for reducing tracking error. Moreover, the module 203 provides an option to create or optimize portfolios based on clusters, objective function, factors, minus indices, or other criteria.

With respect to the risk management module 205, this module 205 focuses on the actionable points on a historic, predictive and real-time basis. For instance, the following real-time assessment are supported: portfolio and security sensitivity to factors (e.g., value, trend, etc.); security/portfolio/holdings exposure and give indicators for loss or hedge thresholds and action triggers; opinions within a given text across news, social media etc. as it relates to the fund, portfolio, holdings, factor, etc. Additionally, the module 205 can provide sentiment analysis on unstructured text into structured data using, for example, Natural Language Processing (NLP). Further, the module 205 utilizes a mathematically stable risk proxy for portfolio comparisons.

The financial planning module 207 provides accurate forecast of cash flows of assets under various scenarios. For example, the module 207 can generate combined cash flow profiles using a common set of assumptions (e.g., macro, performance measure, etc.). Additionally, the module 207 can conduct stress and scenario analysis on the combined cash flow profiles, factors, etc. The module 207 utilize multi-step and ML illiquid forecasting models for financial planning.

The portfolio management module 209 enables management functions relating to a particular asset, holding, and/or portfolio based on machine learning/deep learning (ML/DL) framework with continuous additions of data, measures and visuals per user requests. The functions of module 209 can be a service that is cloud based, standalone or embedded with an existing system (e.g., third party system 103).

The platform 101 provides evaluation, via the security selection module 211, of the best-performing funds/securities within an asset class, filtered pool or cluster for a given objective function. Such objective function can be based on queries/filters that also combine multiple themes (including pre/post filtering). In one embodiment, the security selection module 211 performs dynamic ranking of securities based on historic or predicted objective functions (e.g., min return of x, max MDD of y, etc). The module 211 can supplement traditional section criteria of performance measures with macro-economic, alternative data and holding data. The module 211 supports a capability to explain to the user why the security was selected (e.g., measures, macro condition, alternative, etc.). The user can specify user-defined performance measures, change weights, or modify the complete selection criteria. As with the other modules, the security selection module 211 can support selection, tracking or comparative purposes, and provide assessment of historic and ongoing tracking error of the selection.

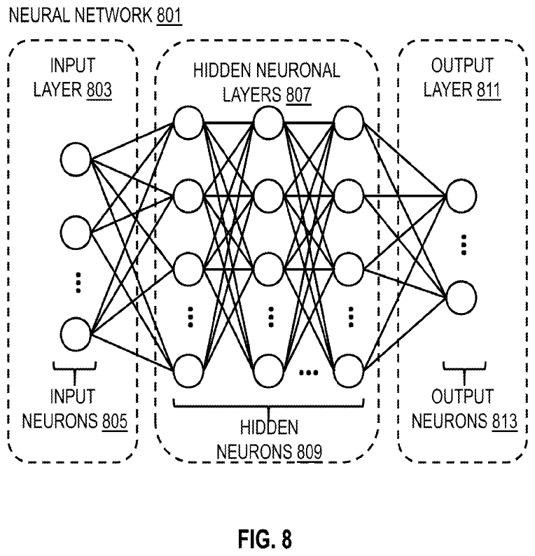

The artificial intelligence engine 213 interact with one or more of the various modules 201-219 to support the functions of the platform 101. By way of example, the AI engine 213 can execute the neural network of FIG. 8.

As depicted, a manager assessment module 215 provides the capability to determine performance indicators relating to how well, for instance, wealth managers manage their portfolios (financial instruments or any asset).

To permit consumers to readily assess such performance, the platform 101 utilizes a sports-based metrics module 217 that converts the performance information from the manager assessment module 215 to analogous or equivalent sports scores and/or statistics (e.g., baseball, golf, etc.). By examining their performance trend lines, the platform 101 can: (a) analyze style drifts, performance under certain conditions, streaks, etc., and (b) match strengths and weaknesses across managers. By way of example, Table 2 lists the rules for generating a golf-based evaluation metric:

TABLE 2

| Terms | Description | Result |
|---|---|---|
| Score | Total score for the periods | Standard deviation of the index returns that |
| | considered or play (e.g., | make the FA pool of managers/assets = 50% |
| | monthly, annual, etc.). Also | Total Score = if IR for total period is |
| | sets the score fo results that | positive then, [sum of the score for the |
| | fall within each range. | individual periods], Absolute [sum of the |
| | | score for the individual periods]. |
| | Par | Score for positive excess returns for the |
| | | period considered within (x) standard |
| | | deviation of target = 0 |
| | Birdy | Score for positive excess returns within (x) |
| | | and (y) standard deviations of target = −1 |
| | Eagle-0 | Score for positive excess returns greater |
| | | than (y) standard deviation of target = −2 |
| | Bogey | Score for negative excess returns within (a) |
| | | standard deviation of the target = +1 |
| | Double Bogey | Score for negative returns between (a) and |
| | | (b) standard deviations of target = +2 |
| | Triple Bogey+ | Score for negative returns greater than (c) |
| | | standard deviation of target = +3 |
| Fairway | Measures the manager's risk | Total of Par and Bogey. |
| Average | taking attitude. Where, a high | |
| | fairway average implies the | |
| | manager may track the index | |
| | more closely and as such is | |
| | not taking much risk (but, if | |
| | they have more Pars than | |
| | bogeys they outperform) and | |
| | vice versa). | |
| Handicap | Measures score consistency. | Average of score of [x] periods when the |
| | | benchmark/index had the highest and |
| | | lowest returns. |

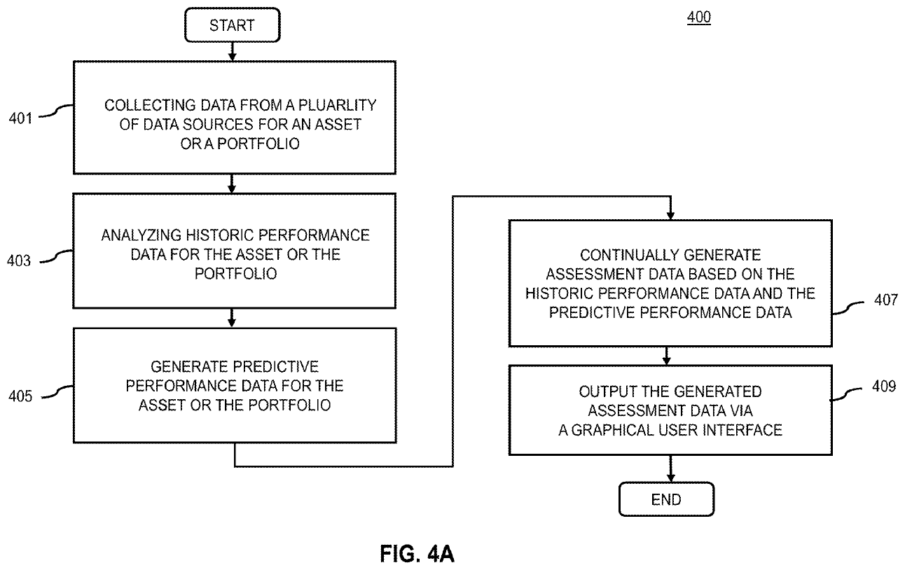

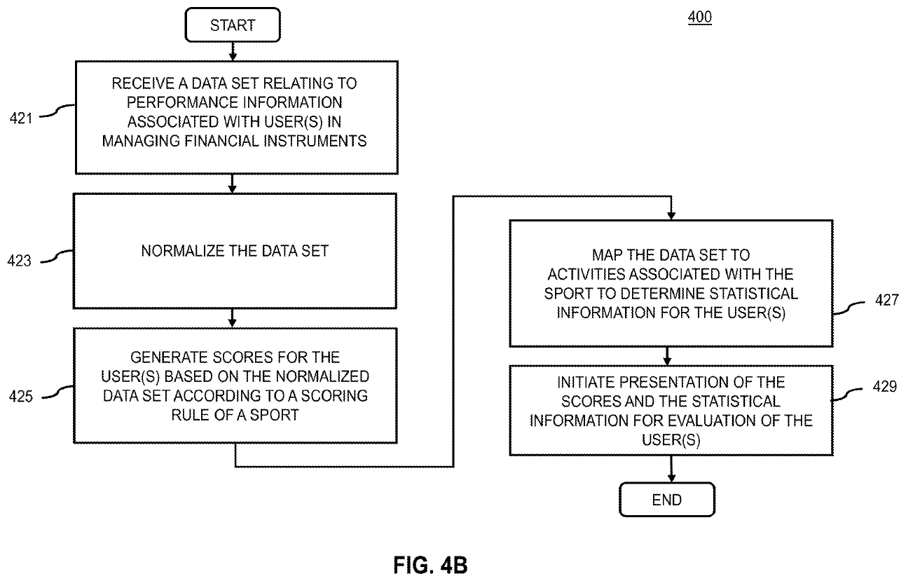

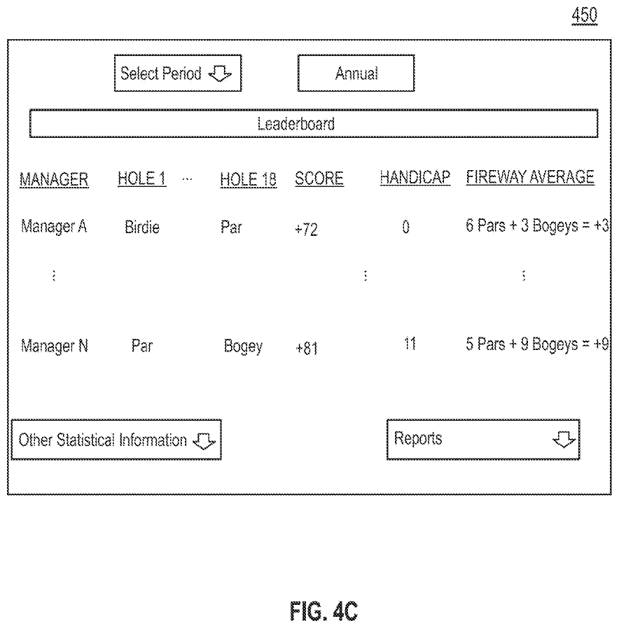

Using the definitions of Table 2, the sports-based metrics module 217 executes the following process: (1) select the asset class, benchmark and periods; (2) calculate the Excess Return by subtracting the manager returns from the benchmark; (3) estimate the standard deviation of the benchmark and set score bins; (4) calculate the score by multiplying the binned results with the score for each bin; and (5) calculate the handicap by averaging a predetermined number of scores (e.g., 4 scores) over a predetermined number of past periods (e.g., 5). These sports-based metrics and associated statistical information can be presented to a consumer to quickly extract performance information about a particular wealth manager, as shown in FIG. 4C.

Alternatively, according to another embodiment, the sports-based metrics module 217 can convert traditional performance metrics to those relating to baseball. For example, the performance indicator can be: batting average. Batting average is the percentage of times the manager meets and/or beats a target. Thus, a 100% batting average indicates that the measured manager has outperformed the target every time; and a 0% batting average indicates that the measured has never beaten or met the target. The application of this simple/intuitive statistical measure is uniform across asset classes, time periods, manager, etc. As a frequency measure, this sports-based metric provides a general directional indicator. In one embodiment, to supplement batting average, another indicator is utilized by the module 217. That is, the module 217 introduces an “information ratio” to provide information about the amount of risk taken or the scale of performance, in recognition that where, it is possible for a manager to have a high batting average (fewer negative surprises) that directionally indicate a good hit rate, but the manager may be underperforming the benchmark as the negative periods may have a higher weighting.

The information ratio is a measure of the excess return over the tracking error for generating the excess returns over the target. Accordingly, higher information ratios imply a level of consistent, risk adjusted outperformance. As a ratio, it does a good job as an indicator of returns per unit of risk; as such, its application is well suited for risk-based (versus absolute) assessments/allocations.

The above presented modules and components of the AI-based decision support platform 101 can be implemented in hardware, firmware, software, or a combination thereof. Though depicted as a separate entity in FIG. 1, it is contemplated that the AI-based decision support platform 101 may be implemented for direct operation by respective UE 105. As such, the AI-based decision support platform 101 may generate direct signal inputs by way of the operating system of the UE 105 for interacting with the applications 107. In another embodiment, one or more of the modules of FIG. 2 and processes of FIGS. 4A and 4B may be implemented for operation by respective UEs, the AI-based decision support platform 101, or combination thereof. Still further, the AI-based decision support platform 101 may be integrated for direct operation with services 115, such as in the form of a widget or applet, in accordance with an information and/or subscriber sharing arrangement. The various executions presented herein contemplate any and all arrangements and models.

FIG. 3 is a diagram of the AI-based decision support platform of FIG. 1 interacting with various data sources, according to one embodiment. The platform 101 architecturally is created in a modular fashion with extensive artificial intelligence-powered data manipulation and analytical capabilities. In one embodiment, the platform 101 has a flexible architecture and is cloud-based. With respect to securities, such as mutual funds and exchange traded funds (ETFs), the platform 101 can collect robust and cleaned dataset. For instance, the platform 101 cleans and processes data from various sources 301 (e.g., market, alternative, client, social, etc.). Additionally, the platform 101 provides the capability to incorporate/append other third-party/unique datasets and advisor holdings. In terms of processing, the platform 101 is modular based on user (e.g., financial advisor) needs and application programming interfaces (APIs) 303 for user ecosystem connectivity. The platform 101 has the capability to select datasets, filters and features for assessment.

Advantageously, the platform 101 provides a seamless, building block framework with continually added depth and breadth. The platform 101 performs an optimized internal processing that mixes-matches AI techniques/models within the modules best suited for a given objective function. The platform 101 measures tracking error, assess “explainability” of results and ability to custom train. Module/version release/accretive analysis is readily provided as the platform 101 operates from Security to Portfolio to Risk Management (and vice versa) for. Security/Portfolio/Risk Management/Signal/+: measures/metrics (e.g., ratios, Greeks, etc.) presented in visually friendly, non-technical way.

The platform 101 covers critical portfolio decision facets. For instance, the platform 101 monitors real time market signals—jumps, trends, sentiment analysis for sectors, industry. The platform 101 also performs security/manager selection based on objective functions-historic or predictive, as well as asset allocation based on market indices or securities (or security proxies). Optimized or behavioral finance-based custom portfolio construction can be performed using, for example, traditional methods, clusters or factors. Portfolios can be replicated using other securities (e.g., replicating mutual fund portfolios using ETFs and/or other optimizations). The platform 101 can assess custom or uploaded portfolios or transitions with varied holdings. Risk management can be overlaid on market/sector/portfolio/security. Further, the platform 101 can perform: Stress testing/Scenario analysis; Factor mapping/sensitivity across all aspects; NLP connect—news/factors; NLP sentiment—news/factors; and/or Risk Watch—alert/hedging/stop loss.

The platform 101 provides comprehensive forecasts for financial planning including incorporating illiquid assets. In this regard, the platform 101 provides: performance/results across various wealth management modules; amplifies existing advisor methods/tools; continual implementation of new research within modules; methods/metrics and publishing research; an entirely AI-based with no legacy technical issues; pool of advanced AI-developers and financial market specialists; an eco-system-engaging renowned AI and finance experts as advisors.

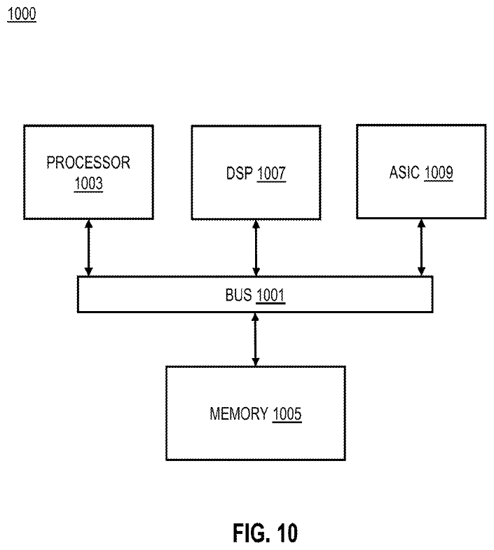

FIG. 4A is a flowchart of a process for assessing performance data by the AI-based decision support platform of FIG. 1, according to one embodiment. In one embodiment, the AI-based decision support platform 101 performs the process 400 and is implemented in, for instance, a chip set including a processor and a memory as shown in FIG. 10. As shown, per step 401, the platform 101 collects data from one or more data sources related to an asset or a portfolio. The platform 101 also analyzes historic performance data for the asset or the portfolio, per step 403. In step 405, predictive performance data is generated for the asset or the portfolio. The platform 101 continually generates assessment data based on the historic performance data and the predictive performance using an artificial intelligence engine, as in step 407. The generated assessment data is output via a graphical user interface of UE 105a, for example (step 409).

FIG. 4B is a flowchart of a process for evaluating wealth managers by the AI-based decision support platform of FIG. 1, according to one embodiment. In step 421, the platform 101 receives a data set relating to performance information associated with one or more users in managing financial instruments. The performance information, for example, includes returns for the financial instruments. Per step 423, the data set is normalized. The platform 101, per step 425, generates a plurality of scores for the user(s) based on the normalized data set according to a scoring rule of a sport. As explained with respect to FIG. 2, the scoring rule can golf, baseball, or any other sport. In step 427, the data set is mapped to activities associated with the sport to determine statistical information for the user(s)—e.g., golf handicap, batting average, etc. The platform 101 then initiates presentation of the scores and the statistical information for evaluation of the user(s), as in step 429. In this manner, the consumer can quickly obtain performance history of a money manager; in which, a low handicap manager is one who meets or exceeds targets more consistently than a high handicap manager. The consumer can also evaluate based on historical golf scores. Similarly, for baseball, a high batting average manager would overall perform better than a low batting average manager. It is contemplated that for any sport, other performance indicators can be utilized to provide greater insight—e.g., number of home runs, etc.

FIG. 4C is a diagram of a graphical user interface (GUI) relating to presentation of performance indicators produced by the AI-based decision support platform of FIG. 1, according to one embodiment. By way of example, GUI 450 pertains to golf and its associated performance and statistical indicators. GUI 450 includes a pull-down button to select the particular period of interest—e.g., under this scenario, the data is “Annual.” This period can then be divided into any number of sub-periods (or “holes”), which in this example is 18 holes, thereby dividing a year into 18 sub-periods. As with golf, the Leaderboard lists performers by the top performer down to the least. Along with the name of the wealth manager, scores for each hole is shown (according to the processes previously described) as well as the manager's handicap and fairway average. In this instance, Manager A, who has a 0 handicap, is the top performer for the selected period. The least performing “player” is Manager N, which is to be expected with a 11 handicap. Handicaps are determined over a number of predesignated periods. GUI 450 can also provide additional statistical information—e.g., number of birdies, number of triple bogies, number of top leaderboards, etc. Moreover, GUI 450 provides for various reports to reveal different analytics (e.g., experience of wealth manager versus performance, etc.).

FIGS. 5A-5H are diagrams of a graphical user interface (GUI) relating to data management processes performed by the AI-based decision support platform of FIG. 1, according to one embodiment. GUIs 501, 503, and 505 permit the user to specify the different types of sources of data to be collected. Such sources can be identified and selected based on asset types, macroeconomic factors, media, or even proprietary data. Via GUIs 507 and 509, the platform 101 can perform predictions on the selected data sources using various models: historic, predicted, stress testing, and/or backtesting for example. According to one embodiment, GUI 511 supports drilling down to permit user input of various aspects of mutual funds. GUI 513 illustrates the clustering feature of platform 101. Additionally, with GUI 515, different views of the data processing of clusters are supported.

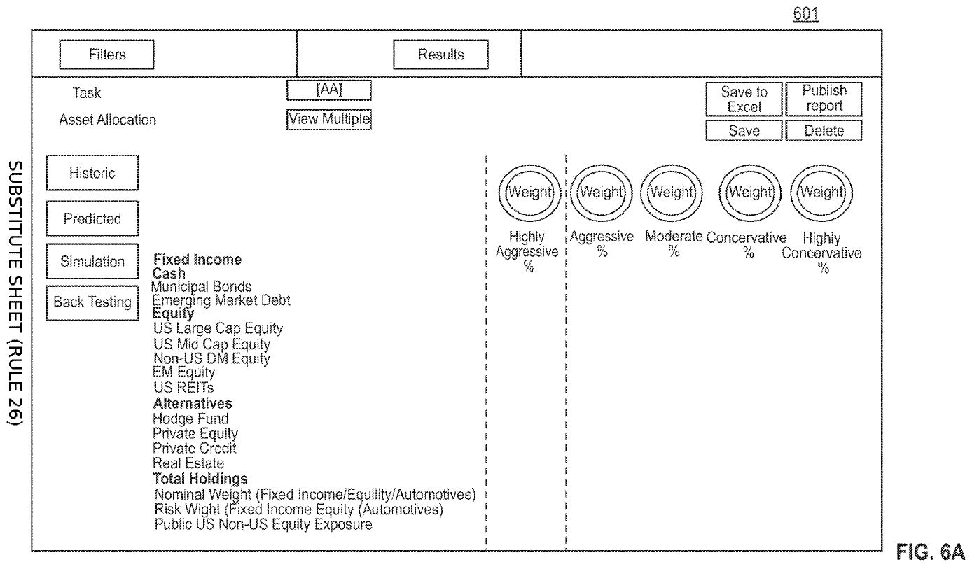

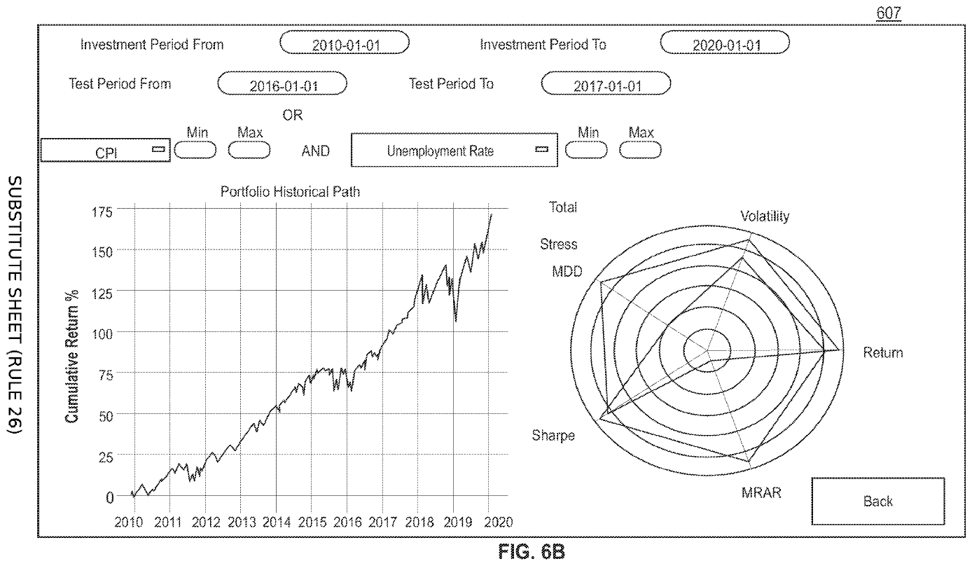

FIGS. 6A and 6B are diagrams of a GUI relating to asset allocation processes performed by the AI-based decision support platform of FIG. 1, according to one embodiment. Namely, through GUIs 601-605, different filters can be applied regarding how asset allocation can be executed. GUI 607 presents performance data associated with a selected asset or cluster of assets.

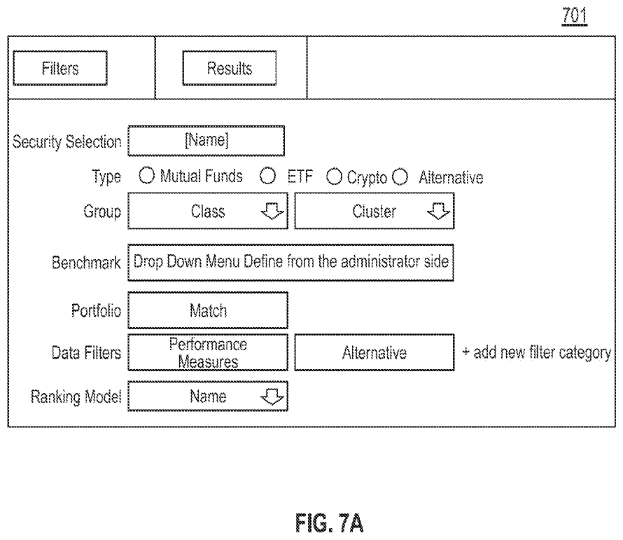

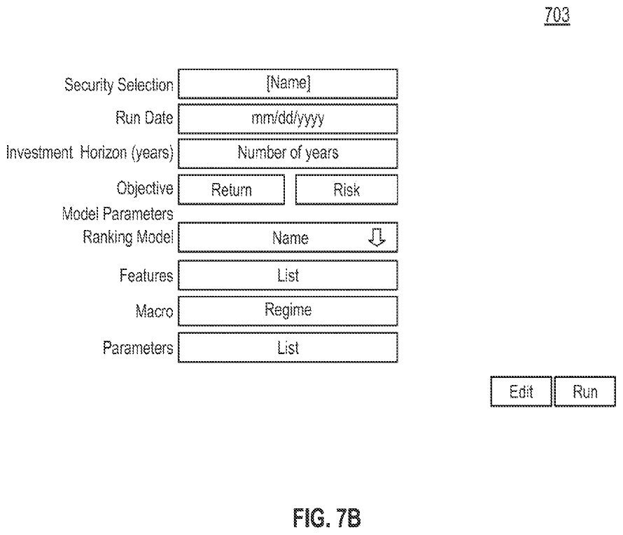

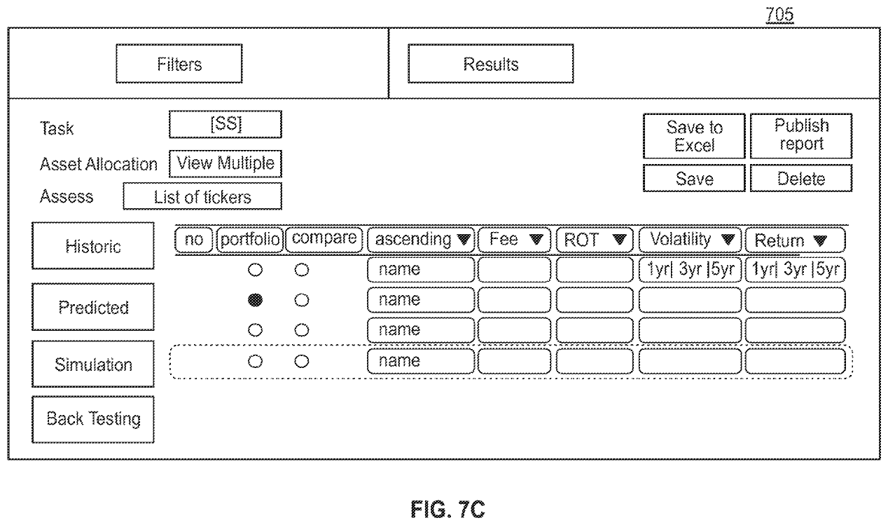

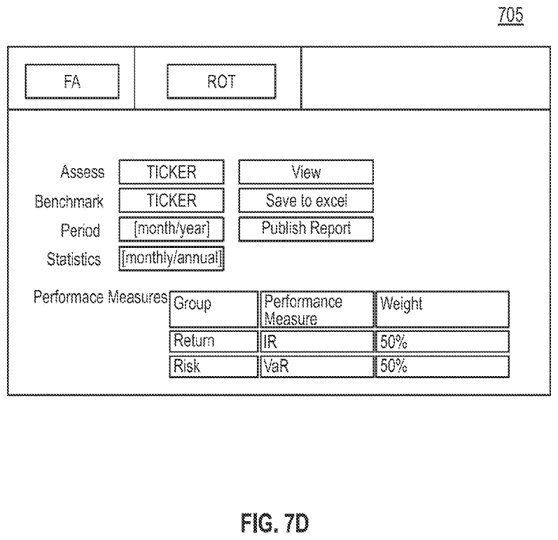

FIGS. 7A-7D are diagrams of a GUI relating to security selection processes and index generation processes performed by the AI-based decision support platform of FIG. 1, according to one embodiment. GUIs 701 and 703, by way of example, provides specification of various data filters for an asset. GUI 705, as in FIG. 7D, provides a section showing categories of performance measures along with the associated weights.

FIG. 8 illustrates an example neural network 801 (e.g., an example of the AI engine 211 implementing a machine learning model) that has an architecture including an input layer 803 comprising one or more input neurons 805, one or more hidden neuronal layers 807 comprising one or more hidden neurons 809, and an output layer 811 comprising one or more output neurons. In one embodiment, the architecture of the neural network 801 refers to the number of input neurons 805, the number of neuronal layers 807, the number of hidden neurons 809 in the neuronal layers 807, the number of output neurons, or a combination thereof. In addition, the architecture can refer to the activation function used by the neurons, the loss functions applied to train the neural network 801, parameters indicating whether the layers are fully connected (e.g., all neurons of one layer are connected to all neurons of another layer) or partially connected, and/or other equivalent characteristics, parameters, or properties of the neurons 805/809/813, neuronal layers 807, or neural network 801. Although the various embodiments described herein are discussed with respect to a neural network 801, it is contemplated that the various embodiments described herein are applicable to any type of machine learning model 109 that can be migrated between different architectures.

In one embodiment, the progressive path migrates an old architecture of a machine learning model 109 into a new architecture by incrementally adding and removing single neurons or neuronal layers, or smoothly changing activation functions in a fashion which does not affect performance of the machine learning model 109 by more than a designated performance change threshold. For example, a user may wish to migrate a machine learning model 109 from an architecture that has three hidden neuronal layers 807 with four hidden neurons 809 in each layer to a new architecture that has four hidden neuronal layers 807 with four hidden neurons 809 each. The machine learning model 109 has been trained using the old architecture for a significant period of time. To advantageously preserve the training already performed and maintain model performance at a target level, the system 100 can construct a progressive path with four steps that incremental adds one hidden neuron 809 to the new neuronal layer 807 at each step until the full new neuronal layer 807 is added. In other words, while the machine learning model 109 of the machine learning system 107 is being trained, a new technical solution or architecture may be discovered that can provide improvements to the machine learning model 109 or system 107. Then instead of replacing the old system architecture in a cut-off fashion, the system 100 can construct incremental steps that can be used to progressively migrate the existing trained machine learning model 109 to avoid catastrophic degradation of the trained machine learning model 109's performance.

In one embodiment, while the progressive migration is being done, the training process continues. In this way, the newly added neurons learn relatively quickly their new roles in the machine learning model 109 as their context environment consists of neuronal layers 807 which already know their jobs (e.g., neuronal layers 807 with neurons 809 that have undergone at least some training). After migration the resulting machine learning model 109 has incorporated expert knowledge from the old architecture, but has a new architecture, new technologies incorporated, and/or the like which can potentially improve the performance and learning of the machine learning model 109 in the future. Accordingly, the embodiments of the system 100 described herein provide technical advantages including, but not limited to, providing long-lived machine learning systems 107 that can be trained better while incorporating new advances in machine learning technologies (e.g., neural network technologies).

The processes described herein for providing decision support may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

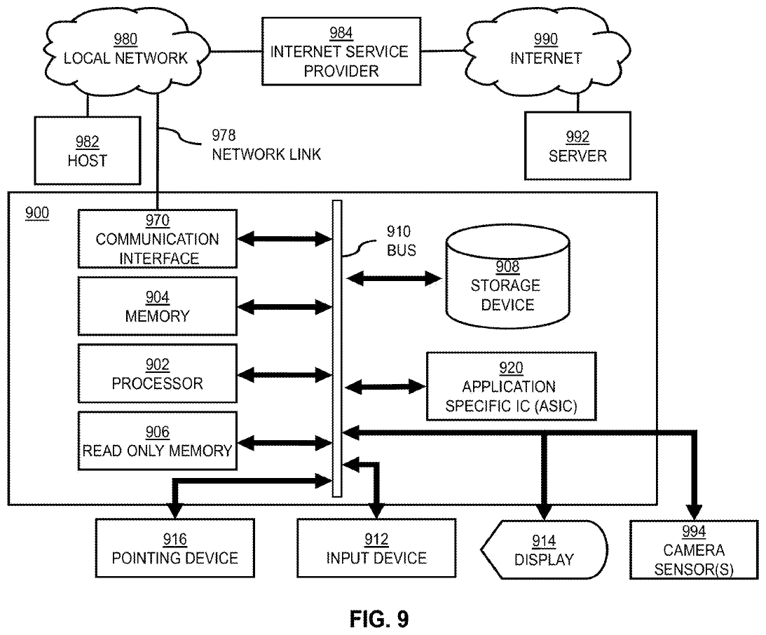

FIG. 9 illustrates a computer system 900 upon which various embodiments of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide decision support as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of the processes described herein, including that of FIG. 4.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing decision support. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for providing real-time data analysis to support decision making. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing real-time data analysis to support decision making, at least in part, on analysis of collected information, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a vacuum fluorescent display (VFD), a liquid crystal display (LCD), a light-emitting diode (LED), an organic light-emitting diode (OLED), a quantum dot display, a virtual reality (VR) headset, a plasma screen, a cathode ray tube (CRT), or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, a display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general, the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 97 in support of the AI-based decision support platform 101.

The term “computer-readable medium” as used herein refers to any medium that participates in providing information to processor 902, including instructions for execution. Such a medium may take many forms, including, but not limited to a computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which various embodiments of the invention may be implemented. Chip set 1000 is programmed to the processes (e.g., FIG. 4) as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing decision support.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide providing decision support. The memory 1005 also stores the data associated with or generated by the execution of the inventive steps.

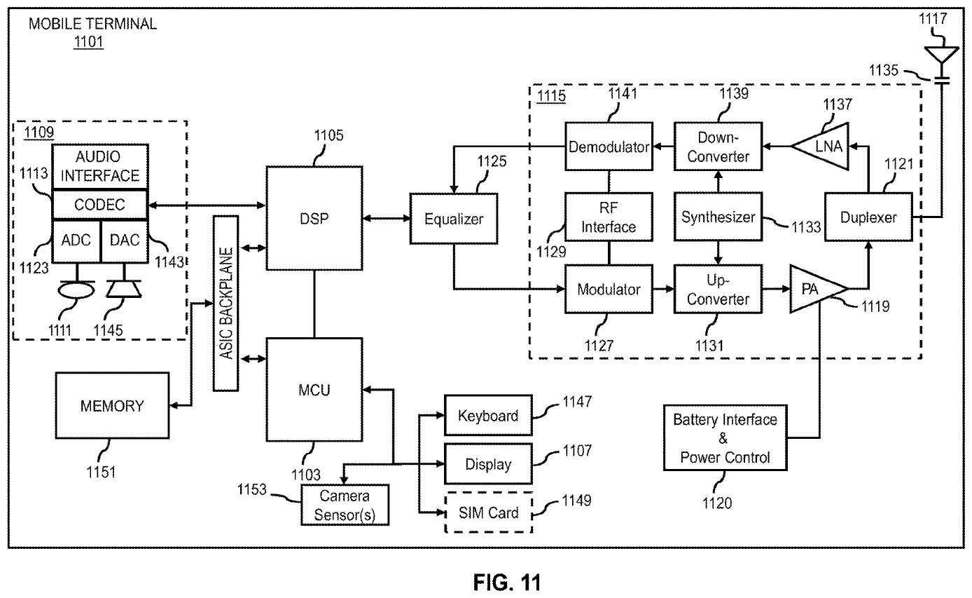

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of the described processes. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing decision support. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies the power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with an RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide decision support. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a data set relating to performance information associated with a plurality of users in managing financial instruments, wherein the performance information includes returns for the financial instruments;
normalizing the data set;
generating a plurality of scores for each of the plurality of users based on the normalized data set according to a scoring rule of a sport;
mapping the data set to activities associated with the sport to determine statistical information for each of the plurality of users; and
initiating presentation of the plurality of scores and the statistical information for evaluation of the plurality of users.

2. The method of claim 1, further comprising:
comparing the normalized data set with a target data set, wherein the plurality of scores are based on the comparison.

3. The method of claim 2, wherein the sport is golf and the scoring rule relates to scoring terms including par, birdy, eagle, bogey, double bogey, and triple bogey.

4. The method of claim 3, further comprising:
presenting the statistical information as textual information including fairway average and handicap.

5. The method of claim 1, further comprising:
determining standard deviation of the data set from the target set, wherein the plurality of scores are based on the determined standard deviation.

6. The method of claim 1, further comprising:
training a machine learning model based on the plurality of scores to generate subsequent scores for each of the plurality of users.

7. A system comprising:
a memory configured to store computer-executable instructions; and
one or more processors configured to execute the instructions to:
receive a data set relating to performance information associated with a plurality of users in managing financial instruments, wherein the performance information includes returns for the financial instruments;
normalize the data set;
generate a plurality of scores for each of the plurality of users based on the normalized data set according to a scoring rule of a sport;
map the data set to activities associated with the sport to determine statistical information for each of the plurality of users; and
initiate presentation of the plurality of scores and the statistical information for evaluation of the plurality of users.

8. The system of claim 7, wherein the one or more processors are further configured to execute the instructions to:
compare the normalized data set with a target data set, wherein the plurality of scores are based on the comparison.

9. The system of claim 8, wherein the sport is golf and the scoring rule relates to scoring terms including par, birdy, eagle, bogey, double bogey, and triple bogey.

10. The system of claim 9, wherein the one or more processors are further configured to execute the instructions to:
present the statistical information as textual information including fairway average and handicap.

11. The system of claim 7, wherein the one or more processors are further configured to execute the instructions to:
determine standard deviation of the data set from the target set, wherein the plurality of scores are based on the determined standard deviation.

12. The system of claim 7, wherein the one or more processors are further configured to execute the instructions to:
train a machine learning model based on the plurality of scores to generate subsequent scores for each of the plurality of users.

13. An apparatus comprising:
at least one processor; and
at least one memory including computer program code for one or more programs,
the at least one memory and the computer program code configured to, with the at least one processor, cause the apparatus to perform at least the following,
receive a data set relating to performance information associated with a plurality of users in managing financial instruments, wherein the performance information includes returns for the financial instruments;
normalize the data set;
generate a plurality of scores for each of the plurality of users based on the normalized data set according to a scoring rule of a sport;
map the data set to activities associated with the sport to determine statistical information for each of the plurality of users; and
initiate presentation of the plurality of scores and the statistical information for evaluation of the plurality of users.

14. The apparatus of claim 13, wherein the apparatus is further configured to execute the instructions to:
compare the normalized data set with a target data set, wherein the plurality of scores are based on the comparison.

15. The apparatus of claim 14, wherein the sport is golf and the scoring rule relates to scoring terms including par, birdy, eagle, bogey, double bogey, and triple bogey.

16. The apparatus of claim 15, wherein the apparatus is further configured to execute the instructions to:
present the statistical information as textual information including fairway average and handicap.

17. The apparatus of claim 13, wherein the apparatus is further configured to execute the instructions to:
determine standard deviation of the data set from the target set, wherein the plurality of scores are based on the determined standard deviation.

18. The apparatus of claim 13, wherein the apparatus is further configured to execute the instructions to:
train a machine learning model based on the plurality of scores to generate subsequent scores for each of the plurality of users.

19. The apparatus of claim 13, wherein the apparatus is further configured to communicate with a mobile computing device over a communication network, the mobile computing device being configured to present the plurality of scores and the statistical information for evaluation of the plurality of users.

20. The apparatus of claim 13, wherein the plurality of users include wealth managers.
